(19) United States
(12) Patent Application Publication
(10) Pub. No.: US 2025/0344655 A1
(43) Pub. Date: Nov. 13, 2025

(54) Urban In-Home System for Growing Fruits and Vegetables

(71) Applicant: Drexel University, Philadelphia, PA (US)

(72) Inventors: Shivanthi Andandan, Philadelphia, PA (US); Diana Susan Nicholas, Bala Cynwyd, PA (US)

(73) Assignee: Drexel University, Philadelphia, PA (US)

(21) Appl. No.: 19/275,080

(22) Filed: Jul. 21, 2025

Related U.S. Application Data
(63) Continuation of application No. 17/265,220, filed on Feb. 2, 2021.

(51) Int. Cl. A01G 31/02; C05B 7/00; C05G 3/50

(52) U.S. Cl. CPC A01G 31/02; C05B 7/00; C05G 3/50

(57) ABSTRACT

An indoor hydroponic device uses cyanobacteria as fertilizer, examining the media composition and nutrient delivery to this hydroponic unit. Due to the use of this fertilizer and the hydroponic setup, the device requires minimal space and maintenance. The device focuses on a) optimizing cyanobacteria and plant growth, b) increasing the efficacy of cyanobacteria as fertilizer, and c) evaluating and enhancing the user's experience with the hydroponic unit.

### CROSS-REFERENCE TO RELATED APPLICATION

The present application claims priority to U.S. Provisional Patent Application Ser. No. 62/713,567, filed on Aug. 2, 2018, which is incorporated herein by reference in its entirety.

### BACKGROUND OF THE INVENTION

### Field of the Invention

The present invention relates to an in-home system for growing fruits and vegetables.

### Description of the Related Art

It is projected that by the year 2050, 68% of the world's population ill live in urban areas. One issue accompanying the increase in urban population is the distance between urban residents and their food sources. One method that can address the problems of urban food access is hydroponic farming. Hydroponics is the practice of growing plants without the use of soil, but instead with a liquid nutrient solution often accompanied by a support medium.

It would be beneficial to provide a hydroponic unit that provides a space and cost-efficient way to increase food access in urban areas.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a system for growing fruits and vegetables. The system includes a frame, a bladder mounted inside the frame, a support disposed within the frame, and a pump located inside the bladder.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a graph of absorbance for all media series over 35 days adjusted for stacked line plot format. Components of media are indicated by line color hue and water type (distilled or tap) is indicated by line color brightness. D stands for distilled water, and T stands for tap water.

FIG. 2 is a graph of average absorbance OD750 (mean±SEM, n=3 for each media formulation) at Day 35. Tap water based media is shown in black and distilled water base media is shown in gray.

FIG. 3 shows average Anabaena PCC 7120 heterocyst counts (mean±SEM, n=3) at Day 35 in all media formulations. Tap water based media shown in black and distilled water base media shown in gray.

FIG. 4 shows average Anabaena PCC 7120 filament counts (mean±SEM, n=3) in different media formulations at Day 35. Tap water based media shown in black and distilled water base media shown in gray.

FIG. 5 is a graph showing average Anabaena PCC 7120 filament counts in all media formulations over 35 days (n=3 at each timepoint).

FIG. 6 is a graph showing average Anabaena PCC 7120 OD750 in different media formulations over 35 days (n=3 at each timepoint).

FIG. 7 is a graph showing absorbance (OD750) of liquid cultures started from agar chips over 35 days. Media inoculated with 1.5% agar chip is indicated by a solid line. Media inoculated with a 0.5% agar chip is indicated by a dashed line.

FIG. 8 shows absorbance OD750 of liquid cultures started from agar chips at Day 35 of growth.

FIG. 9 is a graph showing filament counts in liquid cultures started from agar chips over 35 days. Media inoculated with 1.5% agar chip is indicated by a solid line. Media inoculated with a 0.5% agar chip is indicated by a dashed line.

FIG. 10 shows filament counts in liquid cultures started from agar chips at Day 35. Tap water based media is shown in black and distilled water base media is shown in gray.

FIG. 11 shows heterocyst counts in liquid cultures started from agar chips at Day 35. Tap water based media is shown in black and distilled water base media is shown in gray.

FIG. 12 is a top plan view of a table top plant growth system according to an exemplary embodiment of the invention.

FIG. 13 is a side elevational view of a single table top unit of FIG. 12.

FIG. 14 is a side elevational view of a floor supported plant growth system according to an alternative exemplary embodiment.

FIG. 15 is a top plan view of a wall mounted plant growth system according to an exemplary embodiment.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

The present invention provides a microalgae-fueled hydroponic unit that uses Anabaena PCC 7120 to provide fertilizer through nitrogen fixation. Anabaena is a cyanobacterium capable of nitrogen fixation and has been used as a natural fertilizer for over 1400 years. Using Anabaena to provide fertilizer within a hydroponic unit would eliminate the need for costly and environmentally harmful chemical fertilizers.

Cyanobacteria, which are often erroneously called blue-green algae, are a phylum of bacteria capable of performing photosynthesis. Many species of cyanobacteria are also capable of performing nitrogen fixation, a process that takes atmospheric nitrogen gas and converts it to forms including ammonia, nitrate, or nitrite. These forms of nitrogen can be utilized by plants, and cyanobacteria are often found in symbioses with plants in nature or as biofertilizers in agricultural settings. These multi-talented microbes have significant agricultural, industrial, and scientific applications.

Anabaena sp. PCC 7120 is a filamentous cyanobacterium that has a genome that has been fully sequenced. It is often used as a model organism for cyanobacterial cell differentiation, pattern formation, and nitrogen fixation. In order to perform nitrogen fixation, it produces specialized cells called heterocysts under nitrogen-deprived conditions. There is a division of labor between the heterocystic cells and the vegetative cells: the heterocysts can only perform nitrogen fixation to provide nitrogen and the vegetative cells can only perform photosynthesis to fix carbon dioxide. This joint effort through cellular differentiation allows the Anabaena to persist in adverse conditions, but also provides the tools for the many applications of cyanobacteria.

BG-11 is a commonly used universal medium to culture Anabaena PCC 7120. It is intended for use supporting growth of a wide range of freshwater cyanobacteria and can be initially formulated for culturing on agar plates. The typical formulation of BG-11 involves a high nitrate concentration relative to the phosphate concentration. Table 1 lists the components of BG-11 medium, which are typically mixed with polished distilled water. Due to Anabaena's ability to perform nitrogen fixation, a version of the medium called BG-11 N0 was used. BG-11 N0 lacks the sodium nitrate component of the medium, allowing for heterocyst differentiation and nitrogen fixation.

Since BG-11 is a universal medium not developed specifically for Anabaena PCC 7120, it may contain unnecessary or excess nutrients not required to maintain regular growth. Additionally, tap water sources can contain a variety of mineral, salts, and metals that are capable of supporting cyanobacterial growth.

Hydroponics involves plant cultivation without the use of soil. Plants are fed a liquid nutrient media. It is a highly versatile method of agriculture that allows the growth of plant foods with fewer demands for water, space, and land, making it an excellent fit for urban environments. Anabaena PCC 7120 is a strain of photosynthetic cyanobacteria capable of nitrogen fixation. Due to this ability, Anabaena has a history of use in agriculture as a biofertilizer. In order to optimize efficacy of Anabaena as fertilizer within the hydroponic unit, and to make the growth media accessible to the user, the growth media must be investigated and refined.

TABLE 1

| Component | Name | mg/L Mixed Media | |
|---|---|---|---|
| 1 | Sodium Nitrate - NaNO₃ | 0.150 | mg |
| 2 | Calcium Chloride Dihydrate - CaCl₂ 2H₂O | 0.036 | mg |
| 3 | Ferric Ammonium Citrate - (NH₄)₅Fe(C₆H₄O₇)₂ | 0.012 | mg |
| 4 | EDTA disodium salt - EDTA Na₂ | 0.001 | mg |
| 5 | Potassium Phosphate Dibasic - K₂HPO₄ | 0.040 | mg |
| 6 | Magnesium Sulfate Heptahydrate - MgSO₄ 7H₂O | 0.075 | mg |
| 7 | Sodium Carbonate - Na₂CO₃ | 0.020 | mg |
| 8 | Trace Metal Mix | | |
| | Boric Acid - H₃BO₃ | 0.00286 | mg |
| | Manganese Chloride Tetrahydrate - MnCl₂ 4H₂O | 0.00181 | mg |
| | Zinc Sulphate Heptahydrate - ZnSO₄ 7H₂O | 0.000222 | mg |
| | Sodium Molybdate Dihydrate - NaMoO₄ 2H₂O | 0.000390 | mg |
| | Copper Sulphate Pentahydrate - CuSO₄ 5H₂O | 0.000079 | mg |
| | Cobalt Nitrate Hexahydrate - Co(NO₃)₂ 6H₂O | 0.000049 | mg |

BG-11 media is specifically formulated for the growth of cyanobacteria, but may be modified in order to improve the efficiency of the hydroponic unit. Tap water contains a variety of nutrients that would be redundant with the full BG-11 media. Each of the eight defined components of BG-11 have been eliminated and supplemented with tap water, with observed effects on Anabaena growth. If a single component is found to be unnecessary upon supplementation with tap water, multiple components can be eliminated and the modified media tested for growth.

The present invention also provides methods of using agar within the hydroponic unit to support and improve cyanobacterial delivery to the hydroponic system. Agar is a ubiquitous substance in microbiology with many applications, including providing gel support for nutrient media. In laboratory cultivation of plants, agar can be used to support seed germination and early plant growth. In long term cultivation of cyanobacteria, agar can be used to preserve and store the cyanobacteria for years, with simple rehydration. These uses have been applied to the hydroponic unit that uses cyanobacteria as a biofertilizer. Agar suspensions or coatings of media and Anabaena can provide options for long term storage, transport, and growth optimization. The examples below employ a variety of applications of agar in order to determine its effects on seed germination, plant growth, and nutrient delivery within the context of the hydroponic unit. These applications include agar gels to provide structural support, suspensions of Anabaena, application of Anabaena cultures to agar surfaces, and dehydration and rehydration of agar with Anabaena.

The described experiments provide insight on how to optimize growth of Anabaena within the context of the hydroponic unit. This will increase efficiency and efficacy of the hydroponic unit, making it a better solution to urban food access.

Anabaena PCC 7120, a filamentous, heterocyst-forming cyanobacteria, was selected for its capability of nitrogen fixation and relative hardiness in the laboratory. Starting cultures were maintained in BG-11 N0 media at bench conditions (22-25° C. and 100 μE/m²/s light intensity). BG-11 is a commonly used medium to culture Anabaena PCC 7120 and is intended for use supporting growth of a wide range of freshwater cyanobacteria and was initially formulated for culturing on agar plates. BG-11 N0 lacks the nitrate component typically included in BG-11, omission of which encourages Anabaena heterocyst differentiation needed for nitrogen fixation.

Media were mixed in 250 mL Erlenmeyer flasks with 100 mL of either distilled water filtered through the Milli-Q Integral system (MilliporeSigma, Burlington, MA) or cold tap water. Components of the testing media included 100 ul of each BG-11 component or 1 drop of liquid Miracle-Gro® House Plant Food (Miracle-Gro, Port Washington, NY). See Table 2 for a complete list of each media formulation tested. Media was inoculated with 7 mL of starting culture with an optical density of 0.665 or 0.671 A at 750 nm (OD₇₅₀), beginning at time zero with an OD₇₅₀ ranging from 0.04 to 0.165 A, with the majority within 0.05 to 0.1 A. The inoculated flasks were kept at bench conditions (20-25° C. and 100 μE/m²/s light intensity) and monitored for 6 weeks.

Growth was measured weekly by OD₇₅₀ and filament count. Additionally, samples were observed under the microscope for presence of heterocysts. The volume of the 800 uL samples taken each week was replaced with water appropriate to the media to keep the total volume of the medium constant throughout the experiment.

Optical density measurements at 750 nm (OD₇₅₀), the standard method to determining the total cell density of liquid cultures, was taken with a Spectronic Genesys 5 Spectrophotometer (Thermo Fisher Scientific, Waltham, MA) with an 800 uL sample taken. Before each sample reading the instrument was set to zero with a blank of the same media formulation tested. Filament count was performed by pipetting a 50 uL sample into a hemocytometer (Fisher Scientific, Fair Lawn, New Jersey) and counting filaments within squares representing a 1 mm² area. Heterocyst presence was determined by visual inspection of the microscope field. Heterocyst counts at the final timepoint were performed using the same hemocytometer as the filament counts, counting all heterocysts visible in the delineated a 1 mm² area.

TABLE 2
Composition of media tested.

| Distilled Water | Tap Water |
|---|---|
| BG-11 #2 | BG-11 #2 |
| BG-11 #3 | BG-11 #3 |
| BG-11 #4 | BG-11 #4 |
| BG-11 #5 | BG-11 #5 |
| BG-11 #6 | BG-11 #6 |
| BG-11 #7 | BG-11 #7 |
| BG-11 #8 | BG-11 #8 |
| BG-11 #3 and #5 | BG-11 #3 and #5 |
| BG-11 Complete | BG-11 Complete |
| Water Only | Water Only |
| Miracle-Gro | Miracle-Gro |

Agar “chips” were made by suspending live Anabaena in warm, molten BG-11 N0 agar. 60 mL of dense culture of OD₇₅₀ equal to 1.940 was added to each of 500 ml of 0.5% and 1.5% w/v molten Phytoagar (bioWORLD, Dublin, OH) media formulations. Plates were poured using 20 ml of this suspension per plate then incubated for 4 days at 28°-30° C. and 100uE/m2/s light intensity before being moved to bench conditions (20-25° C. and [light]) for 30 days.

The agar chips were removed from the dishes and split in to four quadrants. Each flask was inoculated with a single quadrant. Liquid media were mixed in 500 mL Erlenmeyer flasks with 250 ml of either distilled water filtered through the Milli-Q Integral system or cold tap water. Formulations for each type of water were prepared with complete BG-11 N0 (all) and with water only (none). These conditions were tested for both the 0.5% and 1.5% agar chips for a total of eight flasks. The inoculated flasks were kept at bench conditions (20-25° C. and [light]) and monitored for 6 weeks. Growth was measured weekly by OD₇₅₀, filament count, and heterocyst presence, according to the methods outlined above for the media tests.

In order to determine the minimal media conditions for robust growth of Anabaena PCC 7120, and to determine how effective tap water is at supplementing media nutrients, various media conditions were tested for micro-algal growth and heterocyst differentiation.

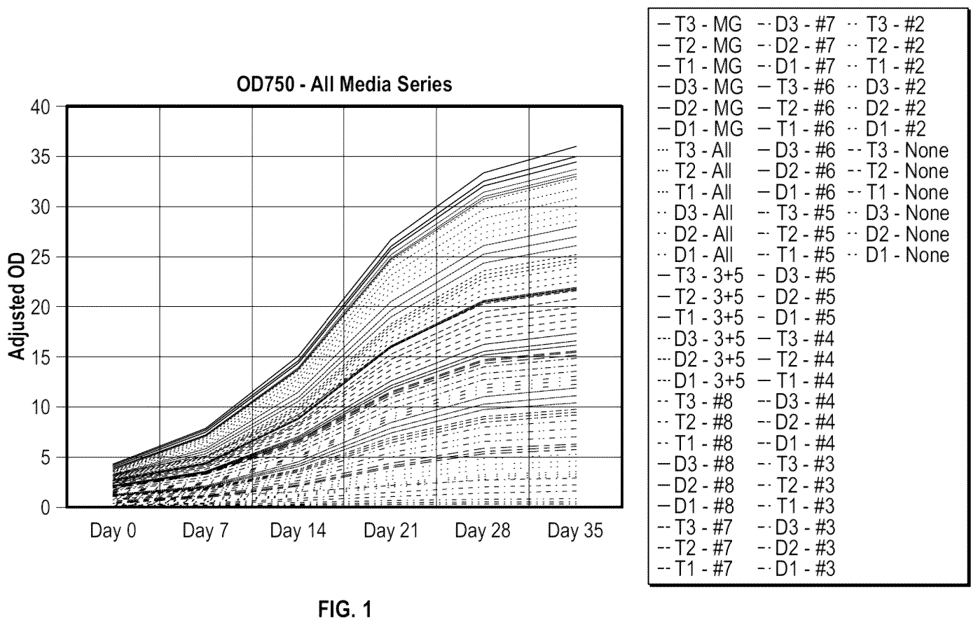

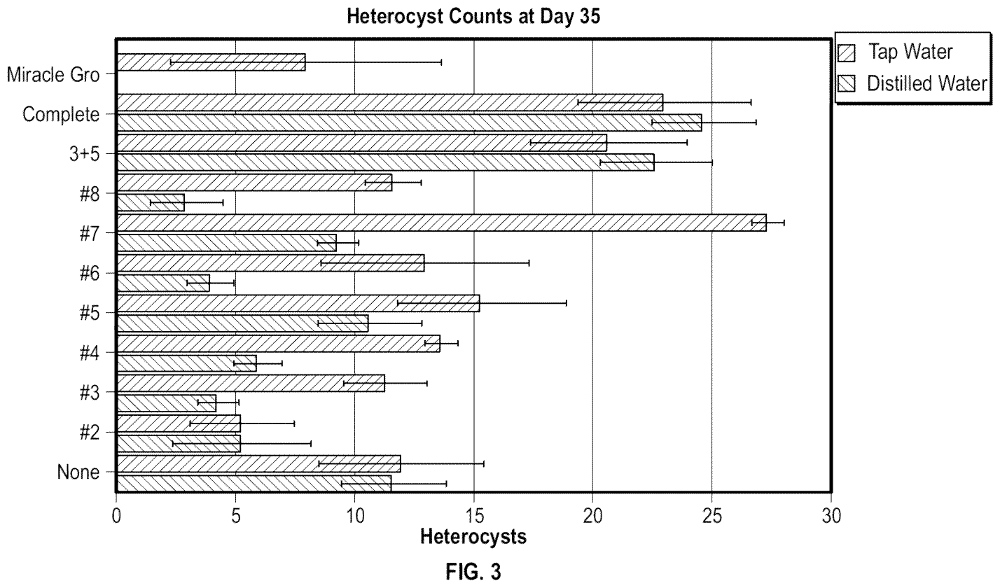

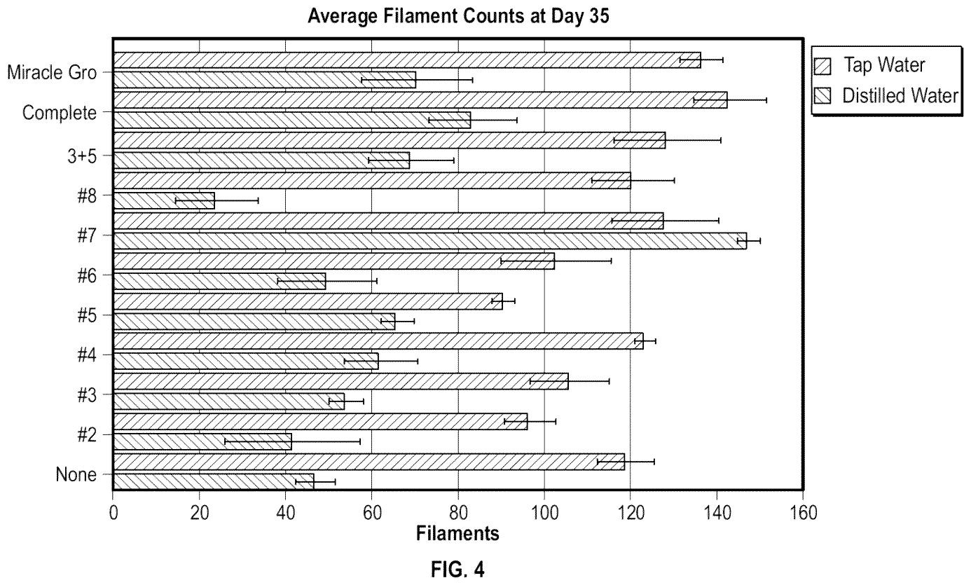

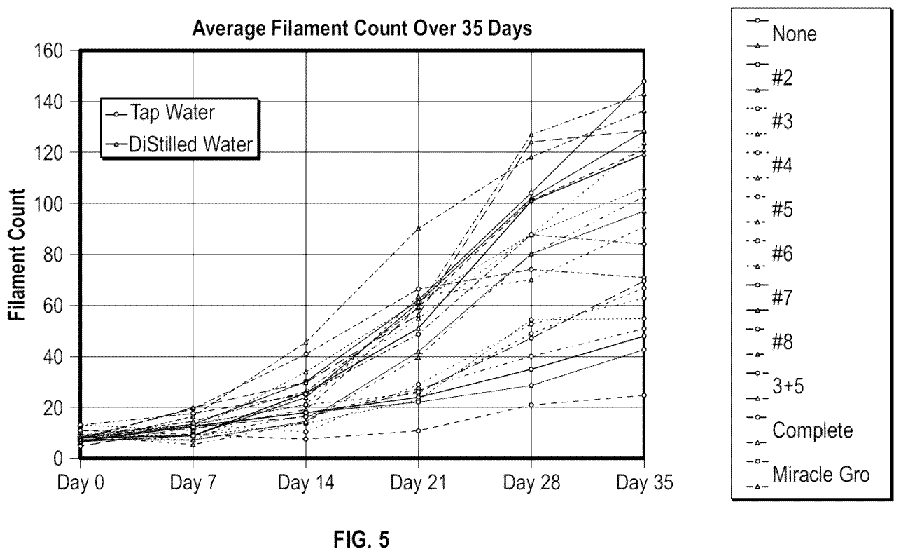

The results indicate that all tap water media formulations had higher OD₇₅₀ values at the final timepoint than the corresponding polished distilled water formulations (FIGS. 1, 2, and 6). Except for formulations with component #7 and complete BG-11N0, all tap water media formulations also had higher filament counts at the final timepoint (FIGS. 4 and 5). Heterocyst counts at the final timepoint for were greater for tap water in most media formulations, but many had no significant difference between tap or polished distilled water versions (FIG. 3). Throughout the observations, heterocysts were present in all formulations with enough growth for multiple filaments to be consistently observed in samples, with the exception of the Miracle Gro. Multiple Miracle Gro formulations showed altered cell morphologies that made heterocyst presence unlikely to occur and impossible to distinguish from other cells.

Two-way ANOVA analysis supports that at the final timepoint, after 35 days of growth, the variations seen in OD750, filaments counts, and heterocyst counts, are significant (Tables 3-5) and due to the variables of the media components, the water used in the media, as well as interactions between these variables.

TABLE 3
Two-way ANOVA analysis for the OD750 at Day 35 of growth.
ANOVA—Media OD Day 35

| Source of Variation | SS | df | MS | F | P-value | F crit |
|---|---|---|---|---|---|---|
| Components | 1.05258376 | 10 | 0.10525838 | 13.6494528 | 1.689E−10 | 2.053901 |
| Water | 2.31843788 | 1 | 2.31843788 | 300.645038 | 2.753E−21 | 4.06170646 |
| Interaction | 0.34728412 | 10 | 0.03472841 | 4.5034309 | 0.00021512 | 2.053901 |
| Within | 0.339308 | 44 | 0.00771155 | | | |

TABLE 4
Two-way ANOVA analysis for the filament counts at Day 35 of growth.
ANOVA—Media Filament Count Day 35

| Source of Variation | SS | df | MS | F | P-value | F crit |
|---|---|---|---|---|---|---|
| Components | 25556.1515 | 10 | 2555.61515 | 10.49077 | 8.9157E−09 | 2.053901 |
| Water | 45451.8788 | 1 | 45451.8788 | 186.579425 | 1.9744E−17 | 4.06170646 |
| Interaction | 12879.7879 | 10 | 1287.97879 | 5.2871377 | 4.4378E−05 | 2.053901 |
| Within | 10718.6667 | 44 | 243.606061 | | | |

TABLE 5
Two-way ANOVA analysis for the heterocyst counts at Day 35 of growth.
ANOVA—Media Heterocyst Count Day 35

| Source of Variation | SS | df | MS | F | P-value | F crit |
|---|---|---|---|---|---|---|
| Components | 2634.69697 | 10 | 263.469697 | 13.4277992 | 2.1834E−10 | 2.053901 |
| Water | 485.469697 | 1 | 485.469697 | 24.7420849 | 1.0501E−05 | 4.06170646 |
| Interaction | 535.363636 | 10 | 53.5363636 | 2.72849421 | 0.01059218 | 2.053901 |
| Within | 863.333333 | 44 | 19.6212121 | | | |

Of the tap water formulations showing robust growth, tap water with combined components #3 and #5 had the highest OD₇₅₀ of 0.925. Tap water with complete BG-11 N0 followed with an OD₇₅₀ of 0.894. The lowest OD₇₅₀ for a tap water formulation was seen with component #2 at 0.594. Refer to the corresponding figures. In general, distilled water formulations lagged behind tap water formulations, with the highest OD₇₅₀ seen with component #7 and complete BG-11 N0, both with OD₇₅₀ of 0.6787, and the lowest OD₇₅₀ seen with component #8 at 0.092.

The distilled water formulation with component #7 only also had the greatest filament count of 147 filaments at the final timepoint, followed by the tap water formulation of complete BG-11 N0 with 143 filaments, then the tap water formulation of Miracle Gro at 136 filaments (FIG. 4). The lowest filament count was seen in the distilled water formulation of Component #8 with 24 filaments.

The highest heterocyst count was seen in the tap water formulation with component #7 at 27 heterocysts, while the distilled formulation of Miracle Gro had zero heterocysts at Day 35 (FIG. 3).

For application of Anabaena PCC 7120 as fertilizer in a hydroponic unit, dehydrated agar chips were tested for efficacy of delivery of Anabaena into the media. For this purpose, Anabaena PCC 7120 were initially grown on agar as described in Chapter 2 Materials and Methods, and the agar chips added to liquid media formulated with either distilled or tap water.

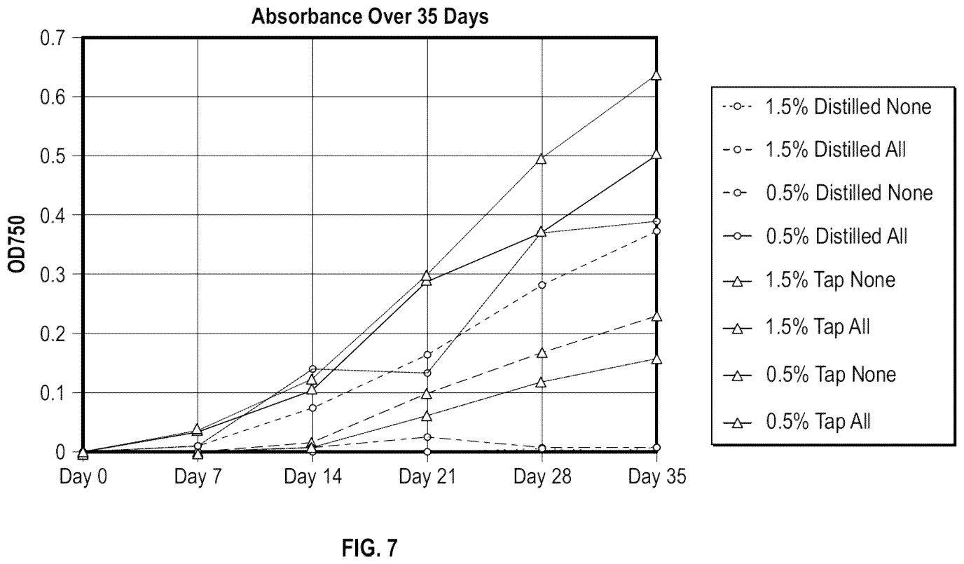

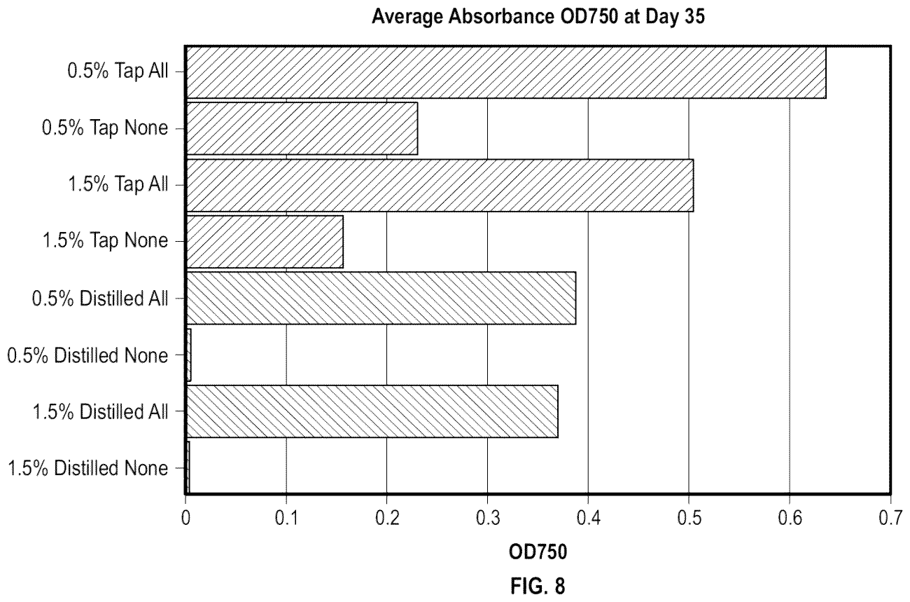

The results indicate that in all media formulations, the cultures in liquid media with tap water formulations had higher OD750 values at the final timepoint at Day 35 than the corresponding polished distilled water formulations (FIGS. 7 and 8). Additionally, all complete BG-11 N0 formulations had higher OD750 than formulations with water alone. Media inoculated with Anabaena grown on a 0.5% agar chip had greater OD750 than media inoculated with Anabaena grown on 1.5% agar chips at the final timepoint, with the exception of the distilled polished water and distilled polished complete BG-11 N0 formulations, which were not significantly different. The complete BG-11 N0 tap water formulation inoculated with a 0.5% agar chip had the greatest OD750 at the final timepoint. The distilled water only formulations inoculated with a 0.5% or 1.5% chip both had the lowest OD750 at 0.007.

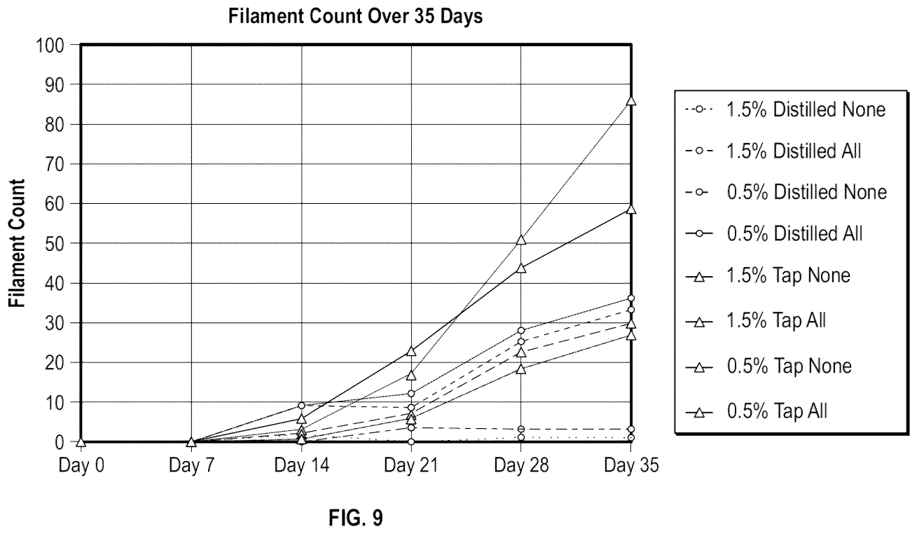

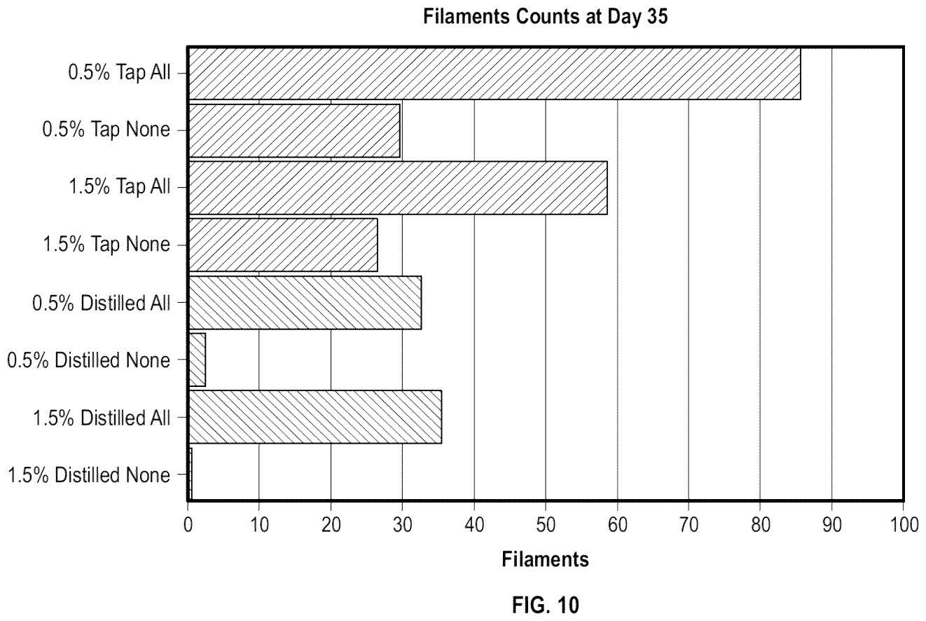

Higher Anabaena PCC 7120 filament counts were seen in the liquid media with tap water formulations compared to the corresponding liquid media with distilled polished water formulations at the final timepoint (FIGS. 9 and 10). Filament counts were also higher in Complete BG-11 N0 (ALL) formulations compared to formulations with water only (NONE). Additionally, media inoculated with Anabaena grown on a 0.5% agar chip had higher filament counts at the final timepoint than the corresponding media inoculated with Anabaena grown on a 1.5% agar chip, with the exception of distilled Complete BG-11 N0.

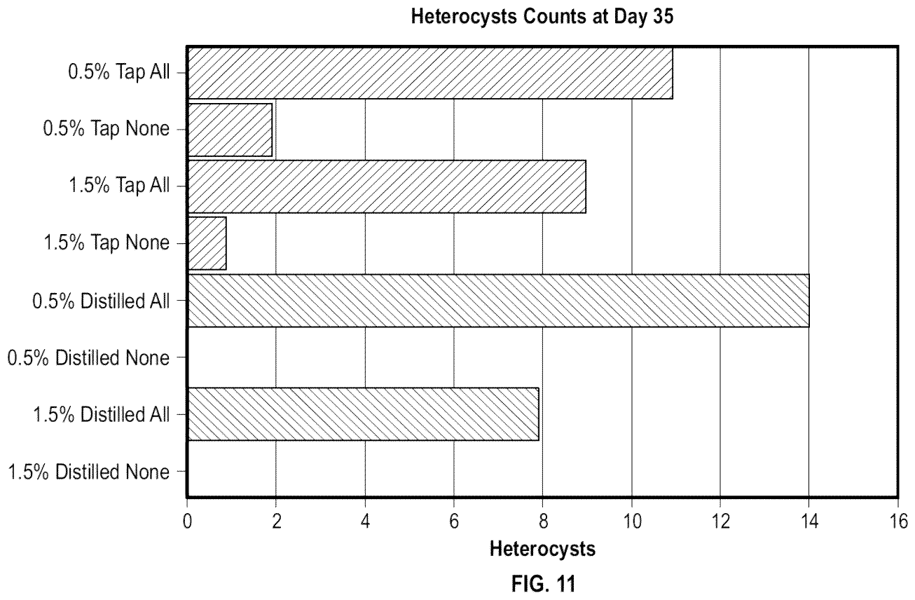

All liquid media formulations and agar chip inoculation types supported robust growth of Anabaena PCC 7120 filaments that were consistently viewed by microscope examination in the sample, and these samples showed the presence of heterocysts (FIG. 11). This indicates that the Anabaena PCC7120 filaments were actively engaged in nitrogen fixation. At the final timepoint, water only media formulations had lower heterocyst counts than Complete BG-11 N0 formulations. Media inoculated with Anabaena grown on 0.5% agar chips showed higher heterocyst counts at Day 35 than media inoculated with 1.5% agar chips.

BG-11 Media was not developed to mimic environmental conditions of any particular cyanobacteria, only to sustain a range of laboratory cultures of freshwater cyanobacteria. The results indicate that Anabaena PCC 7120 can be achieve robust, long term growth with modified versions of BG-11 N0 supplemented with tap water.

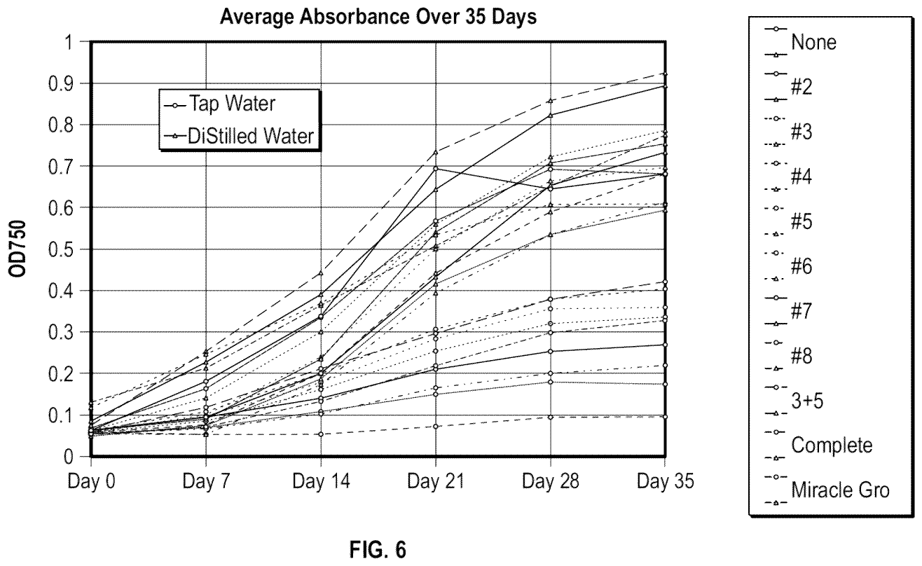

In all the different media formulations used in the experiments, Anabaena grown in tap water media had higher or equivalent OD750 and filament counts compared to their respective distilled water counterparts (FIG. 1). These results support the use of tap water to supplement minimal media formulations. While tap water composition may vary by location and source, the low concentrations of inorganic salts needed to affect Anabaena growth should be present in the majority of tap water available. One concern in the use of tap water for growth of heterocystous cyanobacteria is the presence of inorganic or organic nitrogen. Heterocyst differentiation is a costly process which Anabaena only performs if available nitrogen concentrations are low. The presence of heterocysts indicated that nitrogen levels in the media were low enough for heterocyst differentiation and nitrogen fixation to occur (FIGS. 3 and 6). According to the 2016 Philadelphia Water Quality Report, the highest reading for nitrate presence in tap water was 4.62 ppm, or 0.07451 mM. The World Health Organization 2017 Guidelines for

Drinking Water Quality list the upper limit for nitrate at 50 mg/L, or 0.8063879 mM. Typically, water that reaches this water level is subject to heavy contamination from agricultural or sewage runoff.³⁴ The nitrate threshold for heterocyst differentiation is below either value. BG-11 media is formulated with inorganic nitrate at a concentration of 24.2 mM. Additionally, any minimal amount of nitrogen present will be quickly depleted by the growth of Anabaena. These results support the ability of the tap water formulations to foster heterocyst differentiation and nitrogen fixation needed for Anabaena's applications as a fertilizer.

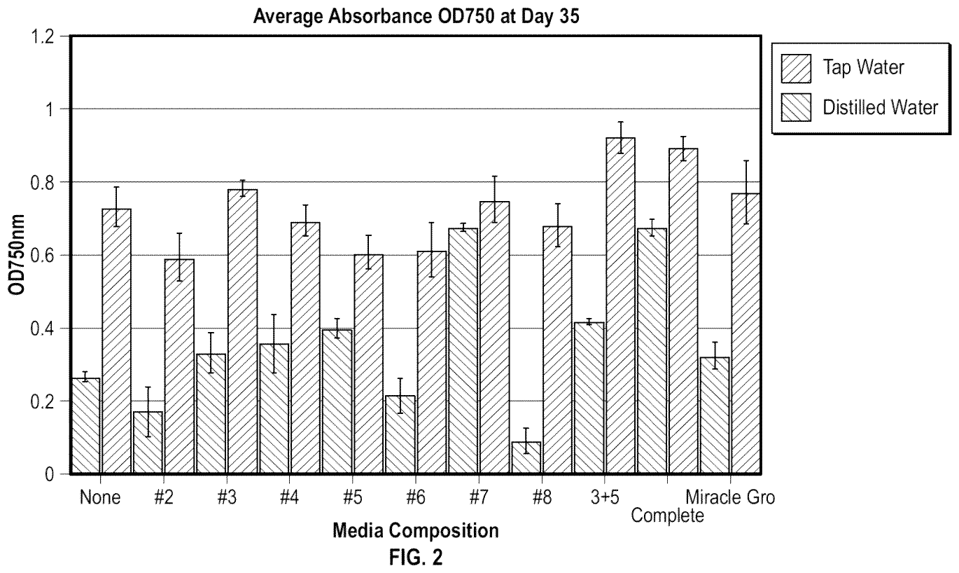

Many of the modified media formulations showed moderate growth of the micro-algae. Media with component #2 only, (Calcium Chloride), and component #6 only, (Magnesium Sulfate) showed moderate growth in both distilled and tap water. Both components contain important macronutrients, with magnesium required for photosynthetic pigments and photosynthetic electron transfer. Growth was increased in tap water versions relative to the distilled water, indicating that tap water was providing some nutrients not found in the modified media (FIG. 2).

Media with component #8 only, the trace metal mix, had the worst growth in distilled water, even less than in distilled water alone. This was surprising because, although it contains only trace metals and minor micronutrients, copper and manganese are needed for photosynthetic electron transfer. When mixed with tap water, growth was more moderate, indicating that the tap water filling in some of the nutritional requirements that were lacking in this formulation.

Media with component #3 only, Ferric Ammonium Citrate, showed moderate growth in distilled water and robust growth in tap water. Iron is an essential component of heme-based electron transport carriers in both photosynthesis and respiration, making it vital for Anabaena growth. Similar growth patterns were seen for media containing component #5 only, Potassium Phosphate, an important macronutrient required for protein and nucleic acid structure. Media with both components #3 and #5 showed robust growth equivalent to that of complete BG-11 N0 media, indicating that Anabaena can be grown successfully in media containing only these two mineral components.

Media with component #4 only, EDTA, showed moderate growth in distilled water and robust growth in tap water. Since EDTA acts as a buffer in BG-11 and can also act as a carbon source and aid in the uptake of other nutrients, this provides explanation for Anabaena's robust growth in tap water.

Media with component #7 only, Sodium Carbonate, also showed robust levels of growth. Sodium carbonate increases the pH of the media and is an inorganic carbon source.

Miracle Gro is a popular indoor plant fertilizer that is available in liquid form. This was tested as a comparison to the modified BG-11 N0 media formulations. Miracle Gro media showed moderate to robust growth. It contains 1.2% Ammoniacal Nitrogen, 1.2% Nitrate Nitrogen, 5.6% Urea Nitrogen, 7% Phosphate, 6% Soluble Potash K20, and 0.10% chelated Iron. The reduced heterocyst presence was expected due to the inclusion of nitrogen. Additionally, at these mineral concentrations there is potential for toxicity. When viewed under the light microscope for filament quantification, there were clear morphological differences in the Anabaena cells grown in Miracle Gro. Miracle Gro grown cells were elongated or grainy in appearance, as compared to the normal rectangular green cells, indicating possible defects in cell division and differentiation.

Heterocysts were present in almost all tested media formulations throughout the observation period, indicating the occurrence of nitrogen fixation. Heterocyst differentiation is a costly, resource-intensive process for Anabaena. The presence of observable, functional heterocysts indicates that Anabaena has be in a nitrogen deficient environment for at least 12-24 hours and has undergone genetic, transcriptional and morphological programming to form heterocysts. Modified media containing only Component #8 did not have observable heterocysts in later timepoints due to a lack of overall growth. Several timepoints for the Miracle Gro formulations also did not have observable heterocysts due to the changes in cell morphology seen. Heterocyst differentiation is also unlikely in this media formulation due to the concentration of nitrogen present in Miracle Gro.

For application of the Anabaena as fertilizer in a hydroponic unit, dehydrated agar chips were tested for efficacy of delivery of Anabaena into the media. The agar chips provide a method for lightweight, easily transported, and user friendly inoculation of the hydroponic unit.

The delivery of Anabaena from the agar chip and subsequent growth in the liquid media largely depended on the availability of nutrients in the media and the concentration of agar in composing the chip. Growth observable by OD750 or filament count was slow, with robust growth not appearing until 14 days after inoculation. This indicates that it takes this time period for the micro-algae to establish themselves successfully and grow in the system. Overall, these results did support the viability of the agar chip as a method of Anabaena delivery.

Distilled water media supported lower levels of growth in comparison to tap water. Tap water contains low levels of inorganic salts and metals that could provide nutrients for the Anabaena, promoting growth. It is also possible that the tap water or its components could break down the agar chip more effectively. The complete BG-11 N0 media formulations had higher levels of growth than the water only formulations, which further indicates the importance of mineral nutrients supporting growth of Anabaena outside of the agar chip. Except for timepoints lacking observable heterocysts due to low growth, all media formulations showed heterocyst differentiation.

The 0.5% w/v agar chips had increased growth outside of the chip compared to the 1.5% w/v agar chips. The decreased agar concentration in the 0.5% possibly allowed the Anabaena to more easily travel from the chip into the liquid media. Additionally, these chips were less solid and their breakdown may have hastened the growth of Anabaena in the liquid medium.

While many of the media formulations showed low growth outside of the agar chip, the robust growth on the chip may be sufficient for this to act as a viable Anabaena delivery system in the proposed hydroponic unit. The Anabaena cells are not required to be free floating throughout the media and plant roots do not have to come into direct contact with the Anabaena for the plants to receive and benefit from the nitrate fertilizer. The minimal extension from the agar chip could be an advantage in that it would limit the Anabaena in circulation in the unit and prevent buildup in the tubing and hardware. Testing of media conditioned by Anabaena growth would provide an opportunity for further investigation and optimization of using this cyanobacterium in the hydroponic system.

The media composition tested has supported the use of tap water, with the addition of BG-11 (see Table 1) components #3 and #5 in the hydroponic media as a method to support robust Anabaena growth. Testing the combination of components #3 and #5 was selected due to preliminary data showing robust Anabaena growth with these components alone relative to growth in media containing the other BG-11 components. In the tests described here, components #3 and #5 did have the greatest growth, but other components also showed robust growth not seen in the preliminary tests. This included media with component #4 and component #7. This presents an opportunity to test other component combinations in further tests, in order to find the optimal tap-water based media composition capable of supporting robust Anabaena growth.

The agar chip delivery system is intended to increase ease of use for the indoor residential context of the hydroponic unit. A small, lightweight, dried chip can more easily and efficiently be packaged, transported, and used for inoculation. The results seen here support that the agar chip can be used successfully to deliver Anabaena culture to liquid media in both tap and polished distilled water formulations. Although the flasks with distilled water alone had low levels of free floating Anabaena in the media, it is possible that, in the context of the complete hydroponic unit, simply having the Anabaena in the same media circulated to the plants, could be sufficient to get the fixed nitrogen and other nutrients to the plants. Further testing will include conditioned media to investigate this possibility, and well as testing variations on the agar chip delivery.

Precedence exists for the suspension of live Anabaena PCC 7120 cells in latex binder to form reactive “leaves” when painted onto a porous surface. This immobilizes the cyanobacteria in a thin layer. This methodology could be applied to the inoculation of the media with Anabaena being delivered by these thin “leaves” or by coating the interior of the unit with the latex polymer suspension. Anabaena can also be suspended in materials such as a silica sol-gel.

The Anabaena PCC 1720 algae described above can be applied to the exterior of an agar chip by any known method, such as, for example, painting, dipping, gravity depositing, or any other method that can be used to apply liquid algae to the surface of agar chip. With such an application, it may be beneficial to provide the agar with a textured surface to increase the surface area of the agar and to provide for better adhesion of the algae on the agar surface. Seeds can be embedded in the agar to feed off the agar/algae combination.

An exemplary agar chip can have a thickness of between about 0.5 mm and about 1.5 mm, although those skilled in the art will recognize that agar chip can have other thicknesses as well.

Alternatively, a latex base can be used to adhere the algae thereto, although latex is not necessarily desired due to the potential for the latex to break down and be absorbed by the plant.

Still alternatively, the agar chip can be melted and mixed with the algae as well as the seeds. The mixture can then be poured into a mold. Algae mixed with agar can provide a benefit of a slower release of the algae as water is applied to the algae/agar mix.

The algae grows with the plant so that the algae does not have to be added throughout the growth of the plant. If desired, however, additional algae can be added to any of system 100, 200, 300 described below, as required.

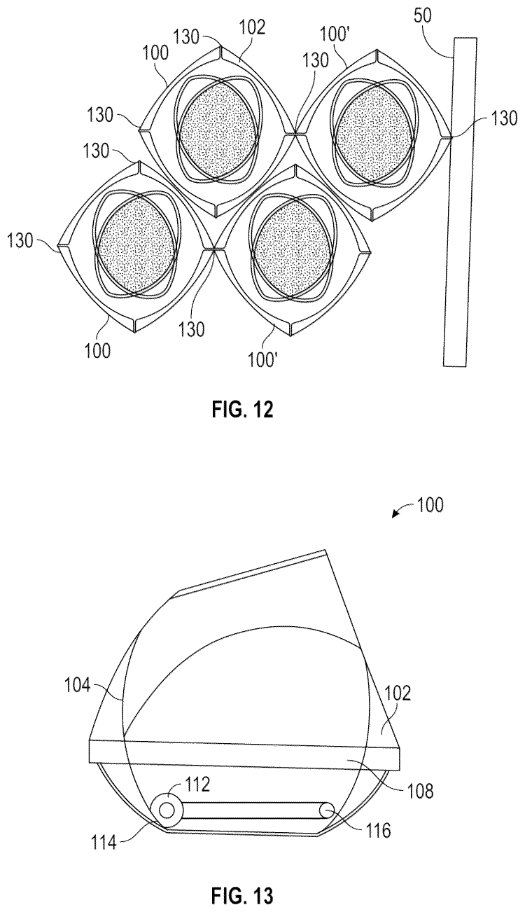

Referring to FIGS. 12 and 13, a table top system 100 (“system”) according to an exemplary embodiment of the present invention is shown. System 100 includes a frame 102 that contains the agar chips and water that is used to irrigate plants growing in system 100. In an exemplary embodiment, as shown in FIG. 12, frame 102 can be generally diamond shaped, with a length of about 8″ and a width of about 4″. A silicone bladder 104 is mounted inside frame 102 and is used to receive and retain water within system 100. In an exemplary embodiment, bladder 104 can be elastic and expandable to fill the inside of the frame 102. Optionally, a layer of latex can be applied inside the bladder 104.

A mesh ledge 108 is horizontally disposed across the frame 102 and is used to support the agar chip and, ultimately, the plant being grown. The plant roots can extend through the mesh ledge 108 and into the water in the bladder 104 to obtain nutrients from the water and subsequently the algae growing in the water.

A pump 112 is located inside bladder 104 and is used to circulate the water in the bladder 104 to keep the water from stagnating. Pump 112 includes a suction end 114 that is below the level of water in the bladder 104. A discharge end 116 of pump 112 is located distal from the suction end 114 of the pump 112 to maximize recirculation of the water in the bladder 104.

The exterior of system 100 includes connectors 130 that can releasably connect a system 100 to an adjacent system 100′ or to a wall 50 (shown in FIG. 12). In an exemplary embodiment, the connectors 130 can be magnetic, although those skilled in the art will recognize that other types of connectors can be used.

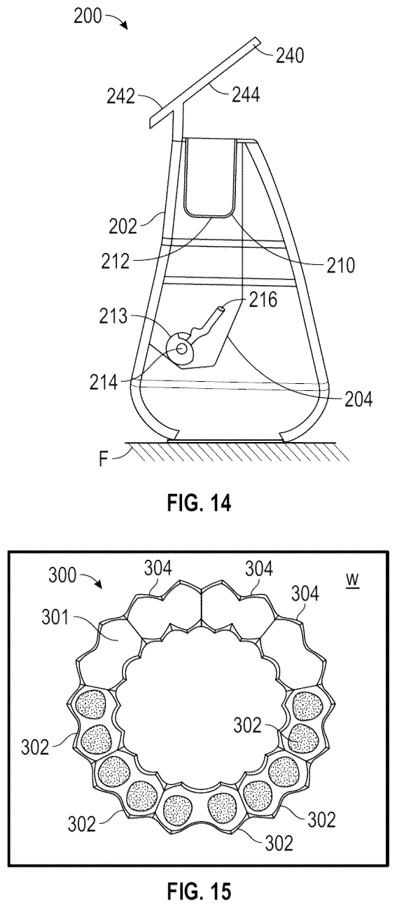

An alternative embodiment of a floor mounted system 200 according to the invention is shown in FIG. 14. In an exemplary embodiment, system 200 extends about 36″ upward from a floor F so that the top of system 200 is proximate to the top of a kitchen counter top. Similar to system 100, system 200 includes a frame 202 that contains the agar chips and water that is used to irrigate plants growing in system 200

A silicone bladder 204 is mounted inside frame 202 and is used to receive and retain water within system 100. In an exemplary embodiment, bladder 204 can be elastic and expandable to fill the inside of the frame 202.

A root cup 210 is removably mounted inside the frame 202. The root cup 210 retains the agar chips and seeds. The bottom of the root cup 210 includes a plurality of openings 212 to allow the plant roots to grow through, as well as to allow any water in the root cup 210 to drain out of the root cup 210.

A pump 213 is located inside bladder 204 and is used to circulate the water in the bladder 204 to keep the water from stagnating. Pump 213 includes a suction end 214 that is below the level of water in the bladder 104. A discharge end 116 of pump 213 is located distal from the suction end 114 of the pump 213 to maximize recirculation of the water in the bladder 104.

System 200 also includes a light panel 240 to provide light to plants growing in system 200. Light panel 240 includes a solar array 242 mounted on a top side of light panel 240, with lights 244 mounted on a bottom side of light panel 240. Solar array 242 generates electricity that is used to power lights 244. In an exemplary embodiment, lights 244 can be LED lights.

Similar to system 100, system 200 can be releasably connected to adjacent systems 200 (not shown).

Another alternative embodiment of a wall mounted system 300 according to the present invention is shown in FIG. 15. System 300 is configured to be mounted on a wall “W”. System 300 can have any of the features described above with respect to systems 100 and 200, particularly with respect to a bladder, a pump and a support means for supporting an agar chip thereon. System 300 can include a plurality of frames 302 connected to each other, with each frame 302 capable of supporting at least two plants, although those skilled in the art will recognize that only a single plant may be provided in each frame 302.

As shown in FIG. 15, five (5) frames 302 are provided adjacent each other, forming an arc. Frames 302 can be releasably connected to each other, such as with magnets or other releasable connection means.

An additional four frames 304 are provided to form a “star pattern” with frames 302 as shown in FIG. 15. Frames 304 can include lighting units such as, for example, LED lights, that shine downwardly onto plants in frames 302.

While systems 100, 200, 300 are shown, those skilled in the art will recognize that other systems having a frame, a support for the agar chips, and a water circulation system can be used to grow fruits and vegetables in accordance with the present invention.

It is not necessary or even necessarily desired to totally submerge the roots of the plant in the liquid so as not to drown the roots. In order to contact the liquid with the roots, however, any of the pumps disclosed above can be used to pump the liquid over the roots. Alternatively, a spray mist can be applied to the roots. Still alternatively, any other method to at least periodically introduce the liquid over the roots can be used. Such methods minimize the amount of liquid required to provide sufficient nutrients to the roots.

As an alternative to the distilled water described above, the liquid in systems 100, 200, 300 can be principally a sterilized tap water. An exemplary method of sterilizing the tap water is to boil the tap water, although other methods of sterilizing the tap water, such as, for example, autoclaving the tap water, can be used. In an exemplary embodiment, the tap water can include certain minerals typically found in tap water or, alternatively, certain minerals can be absent from the liquid.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of preparing a system for hydroponically growing plants, the method comprising the steps of:
(a) providing a media selected from the group consisting essentially of an iron compound and a potassium compound to a micro-algae fueled hydroponic unit;
(b) providing a cyanobacterium to the hydroponic unit; and
(c) providing tap water to the hydroponic unit.

2. The method according to claim 1, wherein the iron compound is ferric ammonium citrate.

3. The method according to claim 1, wherein the potassium compound is potassium phosphate dibasic.

4. The method according to claim 1, wherein the cyanobacterium comprises Anabaena sp. PCC 7120.

5. The method according to claim 1, wherein the media consists essentially of both the iron compound and the potassium compound.

6. The method according to claim 1, further comprising, after step (b) and before step (c), forming an agar chip by the method of:
(b) (1) providing an agar comprising the media;
(b) (2) forming a molten agar; and
(b) (3) suspending the cyanobacterium in the molten agar; and
(b) (4) solidifying the agar.

7. The method according to claim 6, wherein the agar chip has a w/v ratio of about 0.5%.

8. The method according to claim 6, wherein step (b) further comprises the step of embedding a plurality of seeds in the agar.

9. The method according to claim 1, wherein step (b) further comprises suspending the cyanobacterium in a latex binder.

10. The method according to claim 1, wherein step (b) further comprises suspending the cyanobacterium in a silica sol-gel.

11. The method according to claim 1, wherein step (b) further comprises applying the cyanobacterium to an exterior of an agar chip.

12. The method according to claim 11, wherein the exterior of the agar chip comprises a textured surface.

13. The method according to claim 1, wherein the tap water comprises minerals, salts, and metals that are capable of supporting growth of the cyanobacterium.

14. A method of preparing a system for hydroponically growing plants, the method comprising the steps of:
(a) providing a media selected from the group consisting essentially of an iron compound and a potassium compound to a micro-algae fueled hydroponic unit; and
(b) providing a culture medium to the hydroponic unit, wherein the culture medium lacks a nitrate component.

15. The method according to claim 14, further comprising the step of:
(c) providing tap water to the hydroponic unit.

16. A method of hydroponically growing plants, the method comprising the steps of:
(a) providing a media selected from the group consisting essentially of an iron compound and a potassium compound to a micro-algae fueled hydroponic unit;
(b) providing a cyanobacterium to the hydroponic unit;
(c) providing a plurality of seeds to the hydroponic unit; and
(d) providing tap water to the hydroponic unit.

17. The method according to claim 16, wherein, after step (d), the cyanobacterium forms filaments.

18. The method according to claim 17, wherein, after 35 days, the filaments had an optical density at 750 nm (OD750) of about 0.925.
